(19) United States
(12) Patent Application Publication
(10) Pub. No.: US 2024/0410074 A1
(43) Pub. Date: Dec. 12, 2024

(54) ELECTRODEPOSITION COATING COMPOSITION AND ITS PREPARATION

(71) Applicant: BASF COATINGS GMBH, Muenster (DE)

(72) Inventors: Hubert THEIL, Frankfurt (DE); Lin WANG, Muenster (DE); Su Jie XING, Shanghai (CN); Pattarasai TANGVIJITSAKUL, Shanghai (CN)

(21) Appl. No.: 18/697,603

(22) PCT Filed: Oct. 18, 2022
(86) PCT No.: PCT/EP22/78909

§ 371 Date: Apr. 1, 2024

(30) Foreign Application Priority Data
Nov. 4, 2021 (WO) PCT/CN21/128756

(51) Int. Cl. C25D 9/02

(52) U.S. Cl. CPC C25D 9/02

(57) ABSTRACT

Disclosed herein is a cathodic electrodeposition coating composition, which includes (A) a cationic amino-containing epoxy resin, (B) a blocked polyisocyanate having neutralized amine, which is obtained by a process including steps of (i) reacting a polyurethane prepolymer containing isocyanate groups with at least one blocking agent selected from the group consisting of oximes, pyrazoles and active methylene compounds, to provide a partially blocked polyisocyanate, (ii) reacting remaining isocyanate groups in the partially blocked polyisocyanate with an amine compound having active hydrogen, to provide an amine-containing blocked polyisocyanates, and (iii) neutralizing the amine-containing blocked polyisocyanates with an acid, and (C) a curing catalyst. Further disclosed herein are a process for preparing the cathodic electrodeposition coating composition, and a coating bath for the cathodic electrodeposition including the cathodic electrodeposition coating composition.

### FIELD OF THE INVENTION

The present invention relates to cathodic electrodeposition coating materials comprising a self-emulsifying blocked polyisocyanate and use of the self-emulsifying blocked polyisocyanate.

### BACKGROUND OF THE INVENTION

Cathodic electrodeposition coating materials have been widely used in various fields due to excellent application performance thereof and excellent properties of the obtained coating films. Cathodic electrodeposition coating materials generally comprise a part of binder dispersion comprising a resin component (e.g., cationic amino-containing epoxy resin) and a curing agent component (e.g., blocked polyisocyanate) in an aqueous medium, and a part of pigment paste. The binder dispersion is generally prepared by mixing the resin component and the curing agent component, and then neutralizing and dispersing in an aqueous medium. The neutralized resin component and the curing agent will be present together in from of charged micelles in the binder dispersion. There is a fair chance for the two components to react with each other during storage of cathodic electrodeposition coating composition and during the long-term circulation of electrodeposition coating bath.

During electrodeposition coating, the substrate to be coated is used as the cathode. A current is applied between the cathode and an anode as counter electrode such that the micelles containing the neutralized resin component and the curing component in the coating bath are deposited on the metal substrate to form a coating film. The substrate as coated is then subjected to heating in order to cure the coating film, commonly at a temperature of higher than 160° C.

In recent years, there is an emerging demand for cathodic electrodeposition coating materials that are able to perform curing at a lower temperature (i.e., low-temperature curable cathodic electrodeposition coating materials), particularly from original equipment manufacturer in automotive fields. Low-temperature curable cathodic electrodeposition coating materials were known in the art, which generally comprise a curing agent that can exhibit reactivity at lower temperatures. The curing agents are for example oxime blocked polyisocyanates as described in JPH10120947A and JPH07300698A.

However, the improved reactivity of the electrodeposition coating materials may in turn result in reduced stability, for example long-term storage stability and/or working stability during electrodeposition coating. The obtained coating films may have poor appearance and properties. Solutions to the problem have been proposed. For example, EP3415574B describes a process for producing an electrodeposition coating composition having a curability at low temperatures. The electrodeposition coating composition in the patent was prepared by mixing an aqueous dispersion of an amino group-containing epoxy resin (A), an aqueous dispersion of a blocked polyisocyanate compound (B), and a pigment dispersion paste (C), wherein an emulsifier is needed to provide the aqueous dispersion of a blocked polyisocyanate compound (B).

There is still need of low-temperature curable cathodic electrodeposition coating materials having improved storage and working stability. It will be desirable if the low-temperature curable cathodic electrodeposition coating materials can further have improved application performance such as throw power and VOC, and/or generate coating film with better properties such as corrosion resistance.

### SUMMARY OF THE INVENTION

It is an object of the present invention to provide cathodic electrodeposition coating materials that can be cured at a lower temperature than 160° C. and have improved stability, preferably have improved application performance and can provide better coating film properties such as corrosion resistance.

It has surprisingly been found that the object was achieved by using a self-emulsifying blocked polyisocyanate having neutralized amine in cathodic electrodeposition coating materials.

Accordingly, the present invention provides a cathodic electrodeposition coating composition, which comprises
(A) a cationic amino-containing epoxy resin, and
(B) a blocked polyisocyanate having having neutralized amine, which is obtainable or obtained by a process comprising steps of
(i) reacting a polyurethane prepolymer containing isocyanate groups as polyisocyanate with a blocking agent selected from oximes, pyrazoles and active methylene compounds, to provide a partially blocked polyisocyanate,
(ii) reacting remaining isocyanate groups in the partially blocked polyisocyanate with an amine compound having active hydrogen, to provide an amine-containing blocked polyisocyanates, and
(iii) neutralizing the amine-containing blocked polyisocyanates with an acid, and
(C) a curing catalyst.

In another aspect, the present invention provides a method for preparing cathodic electrodeposition coating compositions, which comprises mixing an aqueous dispersion comprising (A) cationic amino-containing epoxy resin with an aqueous dispersion comprising (B) blocked polyisocyanate having neutralized amine.

In a further aspect, the present invention provides a coating bath for cathodic electrodeposition comprising the invented cathodic electrodeposition coating composition or a cathodic electrodeposition coating composition prepared by the invented method.

### DETAILED DESCRIPTION OF THE INVENTION

The present invention now will be described in detail. It shall be understood that the present invention may be embodied in many different ways and shall not be construed as limited to the embodiments set forth herein. Unless mentioned otherwise, all technical and scientific terms used herein have the same meaning as commonly understood by one of ordinary skill in the art to which the present invention belongs.

Herein, the singular forms “a”, “an” and “the” include plural referents unless the context clearly dictates otherwise.

The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

The term “self-emulsifying” as used herein within the context of the blocked polyisocyanate is intended to mean that the blocked polyisocyanate can form a stable dispersion without the necessity of using added surfactants, such as emulsifier or dispersing agent.

The term “prepolymer” as used herein refers to a monomer or system of monomers that have been reacted to an intermediate molecular mass state that is capable of further polymerization by reactive groups to a fully cured high molecular weight state.

### Cathodic Electrodeposition Coating Composition

### (A) Cationic Amino-Containing Epoxy Resin

The cationic amino-containing epoxy resin is used as a binder in the cathodic electrodeposition coating composition, which has positive charges needed for electrodeposition. The positive charges may be generated by neutralizing an amino-containing epoxy resin with a water-soluble acid.

Suitable amino-containing epoxy resins may be adduct of unmodified or modified polyepoxides with primary or secondary amines, for example as described in EP 1171530 A1, U.S. Pat. Nos. 5,236,564 A, 5,236,564 A and 6,274,649 B.

Examples of suitable polyepoxides include polyglycidyl ethers obtainable from polyphenols and epihalohydrin, more particularly epichlorohydrin. Preferred polyphenols are, more particularly, bisphenol A and bisphenol F. Suitable polyphenols also include, but are not limited to 4,4′-dihydroxybenzophenone, 1,1-bis(4-hydroxyphenyl) ethane, 1,1-bis(4-hydroxyphenyl) isobutane, 2,2-bis(4-hydroxy-tert-butylphenyl) propane, bis(2-hydroxynaphthyl) methane, 1,5-dihydroxynaphthalene, and phenolic novolak resins.

Suitable polyepoxides also include, but are not limited to polyglycidyl ethers of polyhydric alcohols, such as ethylene glycol, diethylene glycol, triethylene glycol, 1,2-propylene glycol, 1,4-propylene glycol, 1,5-pentanediol, 1,2,6-hexanetriol, glycerol, and 2,2-bis(4-hydroxycyclohexyl) propane; polyglycidyl esters of polycarboxylic acids, such as oxalic acid, succinic acid, glutaric acid, terephthalic acid, hexahydrophthalic acid, isophthalic acid, and 2,6-naphthalenedicarboxylic acid; hydantoin epoxides, epoxidized polybutadiene, and polyepoxide compounds obtained by epoxidizing an olefinically unsaturated aliphatic compound.

Modified polyepoxides are polyepoxides in which some of the reactive groups have been reacted with a modifying compound. Examples of modifying compounds include, for example
i) compounds containing carboxyl groups, for example saturated or unsaturated monocarboxylic acids, such as benzoic acid, 2-ethylhexanoic acid, Versatic acid; aliphatic, cycloaliphatic and/or aromatic dicarboxylic acids of different chain lengths, such as (meth)acrylic acid or poly(meth)acrylic acid, adipic acid, sebacic acid, isophthalic acid, fatty acids or dimeric fatty acids; hydroxyalkylcarboxylic acids such as lactic acid, dimethylolpropionic acid; and carboxyl-containing polyesters, or
ii) compounds containing amino groups, for example diethylamine, ethylhexylamine, diamines with secondary amino groups such as N,N′-dialkylalkylenediamines (e.g. dimethylethylenediamine), N,N′-dialkylpolyoxyalkylenamines (e.g. N,N′-dimethylpolyoxypropylenediamine), cyanoalkylated alkylenediamines (e.g. N,N′-bis(cyanoethyl)ethylenediamine), cyanoalkylated polyoxyalkylendiamines (e.g. N,N′-bis(cyanoethyl)polyoxypropylenediamine), polyaminoamides such as amino-terminated reaction products of diamines, polycarboxylic acids, and monocarboxylic acids, or reaction products of one mole of diaminohexane with two moles of monoglycidyl ether or monoglycidyl ester, especially glycidyl esters of alpha-branched fatty acids such as Versatic acid, or
iii) compounds containing hydroxyl groups, for example neopentyl glycol, bisethoxylated neopentyl glycol, neopentyl glycol hydroxypivalate, dimethylhydantoin-N,N′-diethanol, hexane-1,6-diol, hexane-2,5-diol, 1,4-bis(hydroxymethyl)cyclohexane, 1,1-isopropylidenebis(p-phenoxy)-2-propanol, trimethylolpropane, pentaerythritol, or amino alcohols such as triethanolamine, methyldiethanolamine or hydroxyl-containing alkylketimines, such as aminomethylpropane-1,3-diol methylisobutyl ketimine or tris(hydroxymethyl)aminomethane cyclohexanone ketimine, and also polyglycol ethers, polyester polyols, polyether polyols, polycaprolactone polyols, and polycaprolactam polyols of different functionalities and molecular weights, or
iv) saturated or unsaturated fatty acid methyl esters which are transesterified in the presence of sodium methoxide with hydroxyl groups of the epoxy resins.

Primary and/or secondary amines suitable for forming adducts with polyepoxides include, but are not limited to mono- and dialkylamines, such as methylamine, ethylamine, propylamine, butylamine, dimethylamine, diethylamine, dipropylamine and methylbutylamine; alkanolamines, such as methylethanolamine and diethanolamine; dialkylaminoalkylamines, such as dimethylaminoethylamine, diethylaminopropylamine and dimethylaminopropylamine; alkylene polyamines, such as ethylenediamine, propylenediamine, butylenediamine, hexamethylenediamine, diethylenetriamine and triethylenetetramine.

The amines may also contain other groups as well, provided that those groups do not to disrupt the reaction of the amine with the epoxide group and also not lead to any gelling of the reaction mixture. Secondary amines are particularly suitable for forming adducts with polyepoxides.

The amino-containing epoxy resins which have been modified with a modifier selected from polyols, polyether polyols and polyester polyols are particularly suitable for the present invention. There is no particular restriction to the amount of the modifier, which may be for example preferably from 0.1% to 30% by weight, more preferably from 1% to 20% by weight, based on the solid content of the amino-containing epoxy resin.

Suitable acids for neutralizing the amino-containing epoxy resins may be inorganic, for example, hydrochloric acid, sulfuric acid, phosphoric acid, nitric acid, boric acid and perchloric acid. Suitable acids may also be organic, for example mono- or poly-carboxylic acids which is optionally substituted with a hydroxyl group. Particularly, the organic acids may be C₁-C₁₀-monocarboxylic acids, C₁-C₁₀-dicarboxylic acids, C₁-C₁₀-tricarboxylic acids, C₁-C₁₀-hydroxymonocarboxylic acids, C₁-C₁₀-hydroxydicarboxylic acids, C₁-C₁₀-hydroxytricarboxylic acids, and any combinations thereof. Examples of the organic acids may include, but are not limited to formic acid, acetic acid, propanoic acid, butanoic acid, lactic acid, glycolic acid, 3-hydroxy butanoic acid, 2-hydroxyisobutanoic acid, malic acid, oxalic acid, malonic acid, methyl malonic acid, succinic acid, methyl succinic acid, adipic acid, pimelic acid, suberic acid, glutaric acid, citric acid, tartaric acid, fumaric acid, benzoic acid, and any combinations thereof. Suitable organic acids may particularly be selected from formic acid, acetic acid, propanoic acid, lactic acid, oxalic acid, glycolic acid, citric acid, malic acid, adipic acid, succinic acid, fumaric acid, benzoic acid, and any combinations.

The cationic amino group-containing epoxy resin may be introduced into the cathodic electrodeposition coating composition according to the present invention in form of an aqueous dispersion.

The cathodic electrodeposition coating composition according to the present invention may comprise from 30% to 85% by weight, preferably from 40% to 70% by weight by weight of the cationic amino group-containing epoxy resin (A), based on the solids content of the cathodic electrodeposition coating composition.

### (B) Blocked Polyisocyanate Having Neutralized Amine

The blocked polyisocyanate having neutralized amine is used in the cathodic electrodeposition coating composition, which is introduced into the cathodic electrodeposition coating composition according to the present invention in form of an aqueous dispersion. The aqueous dispersion is prepared by a process comprising steps of
(i) reacting a polyurethane prepolymer containing isocyanate groups as polyisocyanate with a blocking agent selected from oximes, pyrazoles and active methylene compounds, to provide a partially blocked polyisocyanate,
(ii) reacting remaining isocyanate groups in the partially blocked polyisocyanate with an amine compound having active hydrogen, to provide an amine-containing blocked polyisocyanates, and
(iii) neutralizing the amine-containing blocked polyisocyanate with an acid and dispersing in water.

The polyurethane prepolymer containing isocyanate groups as polyisocyanate in step (i) may be those derived from polyisocyanate compounds and polyols.

Useful polyisocyanate compounds for deriving the polyurethane prepolymer containing isocyanate groups may include aliphatic, cycloaliphatic and aromatic diisocyanates and polyisocyanates containing three or more isocyanate groups per molecule.

Examples of aliphatic diisocyanates may include, but are not limited to, 1,3-trimethylene diisocyanate, 1,4-tetramethylene diisocyanate, 1,5-pentamethylene diisocyanate, 1,6-hexamethylene diisocyante, 1,2-propylene diisocyanate, ethylethylene diisocyanate, 1-methyltrimethylene diisocyanate, 2-methylpetane diisocyanate, 2,2,4-trimethylhexane diisocyanate, isomers and oligomers thereof.

Examples of cycloaliphatic diisocyanates may include, but are not limited to, isophorone diisocyanate, 1,3-cyclopentane diisocyanate, 1,4-cyclohexane diisocyanate, methylcyclohexane-2,4-diisocyanate, methylcyclohexane-2,6-diisocyanate, dicyclohexylmethane diisocyanate, isomers and oligomers thereof.

Examples of aromatic diisocyanates may include, but are not limited to, 1,3-phenylene diisocyanate, 1,4-phenylene diisocyanate, 2,4-tolylene diisocyanate, 2,6-tolylene diisocyanate, 1,3-xylylene diisocyanate, 1,4-xylylene diisocyanate, 1,4-naphthylene diisocyanate, 1,5-naphthylene diisocyanate, biphenylene diisocyanate, 4,4′-diphenylmethane diisocyanate, 2,4′-diphenylmethane diisocyanate, 2,2′-diphenylmethane diisocyanate, 4,4′-diphenyl ether diisocyanate, 2,2-diphenylpropane-4,4′-diisocyanate, isomers or oligomers thereof.

Examples of triisocyanates may include, but are not limited to 1,3,5-triisocyanatobenzene, 2,4,6-triisocyanatotoluene, 1,8-diisocyanato-4-(isocyanatomethyl) octane, lysine triisocyanate, isomers or oligomers thereof.

The oligomers as mentioned above may for example be dimers, dimers, trimers, and higher oligomers such as tetramers, pentamers, hexamers, or a mixture thereof.

According to the present invention, particularly suitable polyisocyanate compounds for deriving the polyurethane prepolymer are those comprising one or more oligomers of 1,3-phenylene diisocyanate, 1,4-phenylene diisocyanate, 2,4-tolylene diisocyanate, 2,6-tolylene diisocyanate, 1,3-xylylene diisocyanate, 1,4-xylylene diisocyanate, 1,4-naphthylene diisocyanate, 1,5-naphthylene diisocyanate, biphenylene diisocyanate, 4,4′-diphenylmethane diisocyanate, 2,4′-diphenylmethane diisocyanate, 2,2′-diphenylmethane diisocyanate, 4,4′-diphenyl ether diisocyanate and 2,2-diphenylpropane-4,4′-diisocyanate.

Preferably, the polyurethane prepolymer containing isocyanate groups is derived from a polyisocyanate compound comprising one or more oligomers of 4,4′-diphenylmethane diisocyanate, 2,4′-diphenylmethane diisocyanate and 2,2′-diphenylmethane diisocyanate.

The polyisocyanate compound can be used alone or as a mixture of two or more species for deriving the polyurethane prepolymer containing isocyanate groups.

The polyols for deriving the polyurethane prepolymer containing isocyanate groups may be for example polyhydric alkanols, polyhydric phenols, (poly) ether polyols, (poly) ester polyols, and polycarbonate polyols.

Examples of polyhydric alkanols may include, but are not limited to glycols such as ethylene glycol, 1,2-propanediol, 1,3-propanediol, 1,2-butanediol, 1,3-butanediol, 1,4-butanediol, 1,2-pentanediol, 1,4-pentanediol, 1,5-pentanediol, neopentyl glycol, 1,4-hexanediol, 1,5-hexanediol, 1,6-hexanediol, 2,5-hexanediol, 2-methyl-1,5-pentanediol, 3-methyl-1,5-pentanediol, 1,8-octanediol, 1,9-nonanediol, 2,2-diethyl-1,3-propanediol, 2-n-butyl-2-ethyl-1,3-propanediol, 2,2,4-trimethyl-1,3-pentanediol, 2-ethyl-1,3-hexanediol, 2-n-hexadecane-1,2-ethylene glycol, 2-neicosane-1,2-ethylene glycol and 2-n-octacosane-1,2-ethylene glycol, hydrogenated bisphenol A; and trihydric or higher polyhydric alkanols such as glycerol, trimethylolethane, trimethylolpropane, 1,2,6-hexanetriol, pentaerythritol, sorbitol and mannitol.

Examples of polyhydric phenols may for example be polyphenols. Suitable polyphenols may include, but are not limited to bisphenol A, bisphenol F and polyalkoxylated derivatives thereof, for example polyethoxylated bisphenol A. Suitable polyphenols also include, but are not limited to 4,4′-dihydroxybenzophenone, 1,1-bis(4-hydroxyphenyl) ethane, 1,1-bis(4-hydroxyphenyl) isobutane, 2,2-bis(4-hydroxy-tert-butylphenyl)propane, bis(2-hydroxynaphthyl)methane, 1,5-dihydroxynaphthalene, and polyalkoxylated derivatives thereof.

Examples of (poly) ether polyols may include, but are not limited to, oligomeric ether polyols such as diethylene glycol, dipropylene glycol, triethylene glycol, tetraethylene glycol, diglycerol, triglycerol and dipentaerythritol, and polyether polyols such as polyethylene glycols, polypropylene glycols, polybutylene glycols, polytetrahydrofuran (PolyTHF), which polyether polyols preferably have an average molecular weight (Mn) of no higher than 1000, more preferably no higher than 800, most preferably no higher than 700.

Examples of (poly) ester diols may include, but are not limited to, (poly) condensate of polyhydric alcohols such as ethylene glycol, propylene glycol, neopentyl glycol, 1,4-butanediol, 1,4-butenediol, 1,6-hexanediol, furan dimethanol and cyclohexane dimethanol, with polycarboxylic acids such as maleic acid, fumaric acid, itaconic acid, succinic acid, glutaric acid, adipic acid, isophthalic acid, terephthalic acid, phthalic anhydride, dimethyl terephthalate, dimer acids and derivatives thereof.

Examples of polycarbonate polyols may include, but are not limited to, the reaction product of C₂-C₂₀-polyols with diaryl- or dialkyl carbonates such as diphenyl carbonate and dimethyl carbonate, or phosgene. The C₂-C₂₀-polyols may be, for example, ethylene glycol, 1,2-propanediol, 1,3-propanediol, 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, bisphenol A, diethylene glycol, tetraethylene glycol, glycerol, trimethylolethane, trimethylolpropane, 1,2,6-hexanetriol, pentaerythritol, or any combinations thereof.

Examples of commercial polycarbonate polyols are the products from Bayer Material Science AG obtainable under the tradenames Desmophen® C 2100, Desmophen® C 2200, Desmophen® C XP 2613, Desmophen® C 3100 XP, Desmophen® C 3200 XP and Desmophen® C XP 2716.

The polyurethane prepolymer containing isocyanate groups as described herein may be commercially available or may be prepared in situ before reacting with a blocking agent in step (i).

Suitable polyurethane prepolymer containing isocyanate groups may have a content of isocyanate groups in a range of from 70% to 90% by molar, preferably from 70% to 80% by molar, based on the total amount of isocyanate groups and urethane groups in said polyurethane prepolymer.

In some embodiments, the polyurethane prepolymer containing isocyanate groups as prepared in situ is used to react with the blocking agent in step (i). Particularly, the polyurethane prepolymer may be prepared by dosing a polyol as described above into a polyisocyanate compound over a period of time. Any catalysts and organic solvents known for preparing polyurethane may be used, without any particular restrictions.

In this case, the step (i) comprises substeps of (i-1) preparing a polyurethane prepolymer containing isocyanate groups from a polyisocyanate compound and a polyol, and (i-2) reacting the polyurethane prepolymer containing isocyanate groups from (i-1) as polyisocyanate with a blocking agent selected from oximes, pyrazoles and active methylene compounds, to provide a partially blocked polyisocyanate.

Accordingly, in preferable embodiments, the blocked polyisocyanate having neutralized amine is obtained by a process comprising steps of
(i-1) preparing a polyurethane prepolymer containing isocyanate groups from a polyisocyanate compound and a polyol,
(i-2) reacting the polyurethane prepolymer containing isocyanate groups from (i-1) as polyisocyanate with a blocking agent selected from oximes, pyrazoles and active methylene compounds, to provide a partially blocked polyisocyanate,
(ii) reacting remaining isocyanate groups in the partially blocked polyisocyanate with an amine compound having active hydrogen, to provide an amine-containing blocked polyisocyanates, and
(iii) neutralizing the amine-containing blocked polyisocyanates with an acid and dispersing in water.

Preferably, the polyol is dosed into the polyisocyanate compound over a period of time in step (i-1). Any catalysts and organic solvents known for preparing polyurethane may be used in step (i-1), without any particular restrictions. The polyol and the polyisocyanate compound as used in step (i-1) are those as described herein above.

The polyurethane prepolymer containing isocyanate groups as obtained from step (i-1) may have a content of isocyanate groups in a range of from 70% to 90% by molar, preferably from 70% to 80% by molar, based on the total amount of isocyanate groups and urethane groups in said polyurethane prepolymer.

The blocking agent in step (i) or (i-2) may be selected from oximes. Examples of useful oximes may include, but are not limited to formamide oxime, acetaldoxime, acetoxime, methylethyl ketoxime, methylisobutyl ketoxime, diethyl ketoxime, diacetyl monoxime, benzophenoxime, cyclopentanoneoxime, cyclohexanoneoxime, or any combinations thereof. Preferably, methylethyl ketoxime is used as the blocking agent.

The blocking agent in step (i) or (i-2) may be selected from pyrazoles. Examples of useful pyrazoles may include, but are not limited to pyrazole, 3,5-dimethylpyrazole, 3-methylpyrazole, 4-bromo-3,5-dimethylpyrazole, 4-nitro-3,5-dimethylpyrazole, 4-benzyl-3,5-dimethylpyrazole, methyl 5-methylpyrazole-3-carboxylate, 3-methyl-5-phenylpyrazole and 3,5-dimethylpyrazole-4-carboxanilide.

The blocking agent in step (i) or (i-2) may be selected from active methylene compounds. Examples of useful active methylene compounds may include, but are not limited to dimethyl malonate, diethyl malonate, diisopropyl malonate, ethyl acetoacetate, isopropyl acetoacetate, methyl acetoacetate, isopropyl acetoacetate and acetylacetone.

The reaction between the polyisocyanate and the blocking agent may be carried out conventionally, preferably by dosing the blocking agent into the polyisocyanate over a period time. Heating may be applied to the reaction mixture, for example after completion of dosing the blocking agent, to promote the reaction between the polyisocyanate and the blocking agent.

Preferably, the partially blocked polyisocyanate as obtained from step (i) or (i-2) may have a content of remaining isocyanate groups in a range of from 10% to 25% by molar, preferably from 10% to 20% by molar, based on the total amount of isocyanate groups, blocked polyisocyanate groups and urethane groups in said partially blocked polyisocyanate.

The amine compound having active hydrogen as used in step (ii) may be selected from C₃-C₂₀-amine compounds having active hydrogen, such as diethanolamine, methyldiethanolamine (MDEA), triethanolamine (TEA), dimethylethanolamine (DMEA), diethylethanolamine (DEEA), 3-dimethylaminopropane-1,2-diol (DMAPD), 3-diethylaminopropane-1,2-diol (DEAPD), 2-dimethylaminopropane-1,3-diol, 2-diethylaminopropane-1,3-diol, 2-(hydroxyethyl)-2-dimethylaminopropane-1,3-diol (DMTA), 2-(hydroxyethyl)-2-diethylaminopropane-1,3-diol (DETA), N,N-dimethyl-N-(2-hydroxypropyl)amine (DMPA), t-butoxyaminoethoxyethanol (TBAEE), 2-[[2-(dimethylamino)ethyl]methylamino]ethanol (DMAEA), N,N,N′-trimethylaminoethylethanolamine (TMAEEA), tetra(2-hydroxypropyl)ethylenediamine, N,N′-bis(2-hydroxyethyl)ethylenediamine, tetramethylhexamethylenediamine (TMHMDA), 2-(2-aminoethylamine) ethanol, 3-(N,N-dimethylamino)propylamine (DMAPA), bis-(3-dimethylaminopropylamine) (BDMAPA), or any combinations thereof. Preferably, the amine compound having active hydrogen is selected from diethanolamine, methyldiethanolamine (MDEA), 2-[2-(dimethylamino)ethyl]methylamino]ethanol (DMAEA), 3-(N,N-dimethylamino) propylamine (DMAPA), bis-(3-dimethylaminopropylamine) (BDMAPA), and any combinations thereof.

The reaction between the partially blocked polyisocyanate with the amine compound having active hydrogen may be carried out conventionally, preferably by dosing the partially blocked polyisocyanate into the amine compound having active hydrogen over a period time, and vice versa. Heating may be applied to the reaction mixture, for example after completion of dosing, to promote the reaction between the partially blocked polyisocyanate and the amine compound having active hydrogen.

The amine-containing blocked polyisocyanates as obtained in step (ii) are substantially free of isocyanate groups, particularly comprises no detectable isocyanate groups.

Any suitable organic solvents and optionally catalysts known for the reaction between the partially blocked polyisocyanate with the amine compound having active hydrogen may be used in step (ii).

The reactions in step (i) (or steps (i-1) and (i-2)) and in step (ii) may be carried out in same or different organic solvent or solvent mixture. Particularly, the reactions in step (i) (or steps (i-1) and (i-2)) and in step (ii) are carried out in the same organic solvent or solvent mixture. Suitable solvents may be, for example, acetone, butanone, methyl isobutyl ketone (MIBK), cyclohexanone, N-methyl-2-pyrrolidone (NMP), acetonitrile, dimethyl sulfoxide (DMSO), tetrahydrofurane (THF), 1,4-dioxane and C₁-C₄-alkyl-C₁-C₄-alkanoates, and any combinations thereof. The organic solvent or solvent mixture, if used in any step(s), may not be removed from the reaction mixture as obtained from the step(s), and thus will be comprised in the aqueous dispersion of blocked polyisocyanate having neutralized amine.

The amine-containing blocked polyisocyanates as obtained in step (ii) may contain from 30 to 200, preferably from 50 to 180 millimoles (mmol) of amine building units, per 100 g of the amine-containing blocked polyisocyanates, calculated on a basis of solid content.

The amine-containing blocked polyisocyanates may be neutralized with any inorganic or organic acids as a neutralizing agent in step (iii). Suitable inorganic acids may be, for example, hydrochloric acid, sulfuric acid, phosphoric acid, nitric acid, boric acid and perchloric acid. Suitable organic acids may for example be mono- or poly-carboxylic acids which is optionally substituted with a hydroxyl group. Particularly, the organic acids may be C₁-C₁₀-monocarboxylic acids, C₁-C₁₀-dicarboxylic acids, C₁-C₁₀-tricarboxylic acids, C₁-C₁₀-hydroxymonocarboxylic acids, C₁-C₁₀-hydroxydicarboxylic acids, C₁-C₁₀-hydroxytricarboxylic acids, and any combinations thereof. Examples of the organic acids may include, but are not limited to formic acid, acetic acid, propanoic acid, butanoic acid, lactic acid, glycolic acid, 3-hydroxy butanoic acid, 2-hydroxyisobutanoic acid, malic acid, oxalic acid, malonic acid, methyl malonic acid, succinic acid, methyl succinic acid, adipic acid, pimelic acid, suberic acid, glutaric acid, citric acid, tartaric acid, fumaric acid, benzoic acid, and any combinations thereof. Suitable organic acids may particularly be selected from formic acid, acetic acid, propanoic acid, lactic acid, glycolic acid, malic acid, oxalic acid, adipic acid, citric acid, succinic acid, fumaric acid, benzoic acid, and any combinations.

The neutralizing may be carried out in the presence of water, for example by introducing the acid as the neutralizing agent in form of an aqueous solution thereof.

The neutralizing may be carried out with the acid in an equivalent amount in a range of from 20% to 125%, preferably from 30% to 100%, and more preferably from 30% to 90%, based on the amount in molar of amino groups in the amine-containing blocked polyisocyanates.

The dispersing in water in step (iii) may be carried out conventionally, for example by means of stirring. It will be understood that the dispersing may be carried out during the neutralizing or after the neutralizing. Preferably, a separate dispersing operation was carried out after the neutralizing.

According to the present invention, no emulsifier or dispersing agent is necessarily used for the dispersing.

In some embodiments, the dispersing in step (iii) is carried out by mixing the neutralized mixture with water in the absence of any added emulsifier or dispersing agent.

It will be contemplated that an added emulsifier or dispersing agent will improve the stability of a dispersion, and thus the dispersing in step (iii) may be carried out in the presence of an added emulsifier or dispersing agent, although the emulsifier or dispersing agent are not indispensable. In this case, the aqueous dispersion of blocked polyisocyanate having neutralized amine according to the present invention will comprise an emulsifier or dispersing agent.

Any conventional emulsifier or dispersing agent for preparing aqueous dispersions of blocked polyisocyanates may be used, including nonionic, anionic, cationic or zwitterionic emulsifier or dispersing agents. Particularly, a nonionic emulsifier or dispersing agent may be mentioned. Suitable nonionic emulsifier or dispersing agent may be selected from polyalkylene oxides such as polyethylene oxides and polypropylene oxides, ethoxylated or propoxylated fatty alcohols, ethoxylated or propoxylated alkylphenols, ethoxylated or propoxylated fatty acids, ethoxylated or propoxylated fatty esters, sorbitan derivatives, sucrose esters and derivatives, ethylene oxide-propylene oxide block copolymers, fluorinated alkyl polyoxyethylene ethanols, and any combinations thereof.

The aqueous dispersion of blocked polyisocyanate having neutralized amine according to the present invention may further comprises additional components, for example organic solvent, colorant or pigment, viscosity modifier, leveling agent, anti-gel forming agent, light stabilizer, antioxidant, ultraviolet absorber, heat resistance improver, inorganic or organic filler, plasticizer, lubricant, softening agent, antistatic agent, reinforcing agent, and any combinations thereof.

The additional components, if comprised, may be introduced into the aqueous dispersion of blocked polyisocyanate having neutralized amine according to the present invention after step (ii), for example, before the neutralizing in step (iii), between the neutralizing and the dispersing in step (iii) or during the dispersing in step (iii).

The aqueous dispersion of blocked polyisocyanate having neutralized amine according to the present invention may have one or more of following properties,
i) a pH in a range of from 3.0 to 8.0, preferably from 3.5 to 8.0, and more preferably from 4.0 to 8.0, measured at 20° C. according to DIN 55659-1;

ii) a conductivity in a range of from 2 to 10 mS/cm, preferably from 3 to 8 mS/cm, measured at 20° C. according to DIN EN ISO 15091;

iii) a Z-average particle size in a range of from 60 to 200 nm, preferably from 60 to 160 nm, measured according to DIN ISO 13321;

iv) a polydispersity index (PDI) of less than 0.2, an indicator of particle size distribution, measured according to DIN ISO 13321;

v) a solid content of from 10% to 40% by weight, preferably from 15% to 35% by weight, measured according to DIN EN ISO 3251, under 130° C. for 60 mins;

vi) a molar equivalent of acid (MEQ-A) in a range of from 20 to 150 mmol/100 g, preferably from 30 to 120 mmol/100 g, measured according to DIN EN ISO 15880; and

vii) a molar equivalent of base (MEQ-B) in a range of from 30 to 200 mmol/100 g, preferably from 50 to 180 mmol/100 g, measured according to DIN EN ISO 15880.

The component (B), i.e., the blocked polyisocyanate having neutralized amine may account for 100% by weight of curing agent in the cathodic electrodeposition coating composition according to the present invention. Alternatively, the cathodic electrodeposition coating composition according to the present invention may comprise a curing agent (D) other than the blocked polyisocyanate having neutralized amine.

### (C) Curing Catalyst

A curing catalyst is required to facilitate the reaction of cationic amino-containing epoxy resin (A) and the blocked polyisocyanate having neutralized amine building units (B). Any curing catalyst commonly used in electrodeposition coating could be used hereby. Preferably, metal catalyst could be used, for example, triphenyl tin hydroxide, butyl stannoic acid, dioctyltin oxide, dibutyltin dilaurate, dibutyltin diacetate, dibutyltin oxide, oxides of titanium, hafnium, zirconium, niobium, zinc, bismuth, lead, indium, tin, copper and yttrium.

The curing catalyst may be introduced into the cathodic electrodeposition coating composition according to the present invention in a form of paste comprising grinding resin, pigment, filler and catalyst. Said paste may be prepared, for example, by mixing a pigment with a grinding resin for pigment dispersion and neutralizing agent. Examples of suitable grinding resins for pigment dispersion may include, but are not limited to, epoxy resins having hydroxy and cationic groups, acrylic resins having hydroxyl and cationic groups, epoxy resins of tertiary amine type, quaternary ammonium salt type and tertiary sulfonium salt type, and acrylic resins of tertiary amine type, quaternary ammonium salt type and tertiary sulfonium salt type.

Examples of suitable pigments include but are not limited to white pigments such as titanium dioxide, aluminum silicate, silicon dioxide, zinc oxide, zinc sulfide, barium sulfate, calcium carbonate, magnesium carbonate, and magnesium silicate; black pigments such as carbon black, or colored pigments. The colored pigments may include, for example, inorganic chromatic pigments such as iron oxides or chromium oxides, and organic chromatic pigments such as azo pigments, triphenylmethane pigments, indigoid pigments, metal complex pigments, isoindolinones, anthraquinones, perylene and perinone pigments, dioxazine pigments, quinophthalones, diketopyrrolopyrrole or pyrazoloquinazolone pigments.

The curing catalyst may be present separately from the cationic amino-containing epoxy resin (A) and the blocked polyisocyanate having neutralized amine (B) and the optional curing agent (D) and will be mixed with the components (A), (B) and optional (D) immediately before application in a cathodic electrodeposition coating process.

Generally, the cathodic electrodeposition coating composition according to the present invention may comprise the curing catalyst (C) in an amount of from 0.01% to 2% by weight and preferably from 0.05% to 1% by weight, based on the total weight of the cathodic electrodeposition coating composition.

### (D) Curing Agent

Optionally, the cathodic electrodeposition coating composition may comprise an additional curing agent. There is no particular restriction to the optional curing agent that may be used in combination of the blocked polyisocyanate having neutralized amine.

Any conventional blocked polyisocyanates may be used as the optional curing agent in the cathodic electrodeposition coating composition according to the present invention, for example a product from the reaction of a polyisocyanate compound with a blocking agent, and optionally an active hydrogen-containing compound other than the blocking agent.

Examples of suitable polyisocyanate compounds include those as described above for the blocked polyisocyanate having neutralized amine.

Examples of suitable blocking agent may be selected from aliphatic alcohols, such as methanol, ethanol, chloroethanol, propanol, butanol, pentanol, hexanol, heptanol, octanol, nonanol, 3,5,5-trimethylhexanol decanol and lauryl alcohol; cycloaliphatic alcohols such as cyclopentanol and cyclohexanol, and aromatic alkyl alcohols such as phenylcarbinol and methylphenylcarbinol. Other suitable blocking agents may be for example hydroxylamines such as ethanolamine, oximes such as methyl ethyl ketone oxime, acetone oxime and cyclohexanone oxime, or amines such as dibutylamine and diisopropylamine.

The cathodic electrodeposition coating composition according to the present invention may comprise 10% to 40% by weight, preferably 15% to 35% by weight of curing agents in total, including the blocked polyisocyanate having neutralized amine (B) and any optional curing agent (D), based on the solids content of the cathodic electrodeposition coating composition.

The blocked polyisocyanate having neutralized amine (B) may accounts for at least 10% by weight, preferably at least 20% by weight of the total amount of the blocked polyisocyanate having neutralized amine (B) and any optional curing agent (D).

Accordingly, the blocked polyisocyanate having neutralized amine (B) may be present in the cathodic electrodeposition coating composition according to the present invention in an amount of 2% to 40% by weight, more preferably 3% to 35% by weight, based on the solids content of the cathodic electrodeposition coating composition.

The curing agent (D) may be present in the cathodic electrodeposition coating composition according to the present invention in an amount of no higher than 38% by weight, preferably no higher than 32% by weight, based on the solids content of the cathodic electrodeposition coating composition.

The cathodic electrodeposition coating composition according to the present invention may comprise further additives, for example pigments, plasticizers, fillers, wetting agents and catalysts. Particularly the cathodic electrodeposition coating composition may comprise a pigment.

### Method for Preparing Cathodic Electrodeposition Coating Compositions

The present invention provides a method for preparing cathodic electrodeposition coating compositions, which comprises mixing an aqueous dispersion comprising the cationic amino-containing epoxy resin (A) with an aqueous dispersion comprising the blocked polyisocyanate having neutralized amine (B) and a curing catalyst (C).

The cationic amino-containing epoxy resin (A) is as described above. The aqueous dispersion comprising the cationic amino-containing epoxy resin (A) may be prepared by neutralizing an amino-containing epoxy resin with an acid and dispersing in water. Optionally, the aqueous dispersion may comprise additives such as neutralizing agents, emulsifiers, catalysts, and resin components other than the cationic amino-containing epoxy resin (A).

The aqueous dispersion comprising the blocked polyisocyanate having neutralized amine (B) may be prepared by a process as described herein to obtain the blocked polyisocyanate having neutralized amine. The description and preferences above-mentioned for the aqueous dispersion of the blocked polyisocyanate having neutralized amine may be applied here.

The curing catalyst (C) is as described above.

The method for preparing cathodic electrodeposition coating compositions may optionally comprise a curing agent other than blocked polyisocyanate having neutralized amine. The additional curing agent is as described above for the curing agent (D). For example, the additional curing agent may be incorporated into the cathodic electrodeposition coating compositions together with the cationic amino-containing epoxy resin (A).

Particularly, the additional curing agent may be mixed, neutralized and dispersed together with the amino-containing epoxy resin prior to neutralization. In this case, the aqueous dispersion comprising the cationic amino-containing epoxy resin (A) will also comprise the additional curing agent, which may be neutralized if a base group is comprised in the additional curing agent.

In some embodiments, the present invention provides a method for preparing cathodic electrodeposition coating compositions, which comprises steps of
(1) mixing an amino-containing epoxy resin with a curing agent other than the blocked polyisocyanate having neutralized amine (B), neutralizing and dispersing together in water to provide the aqueous dispersion comprising the cationic amino-containing epoxy resin (A) and the additional curing agent,
(2) mixing the obtained aqueous dispersion comprising the cationic amino-containing epoxy resin (A) and the additional curing agent with an aqueous dispersion comprising the blocked polyisocyanate having neutralized amine (B), and
(3) mixing the curing catalyst (C) with the aqueous dispersion comprising the cationic amino-containing epoxy resin (A) and the aqueous dispersion comprising the blocked polyisocyanate having neutralized amine (B) immediately before application in a cathodic electrodeposition coating process.

The curing catalyst may be introduced into the cathodic electrodeposition coating composition according to the present invention in a form of paste comprising grinding resin, pigment, filler and catalyst.

Furthermore, the present invention provides a coating bath for cathodic electrodeposition comprising the invented cathodic electrodeposition coating composition or a cathodic electrodeposition coating composition prepared by the invented method.

### EMBODIMENTS

Various embodiments are listed below. It will be understood that the embodiments listed below may be combined with all aspects and other embodiments in accordance with the scope of the invention.

### Embodiment 1

A cathodic electrodeposition coating composition comprising
(A) a cationic amino-containing epoxy resin, and
(B) a blocked polyisocyanate having neutralized amine which is obtainable or obtained by a process comprising steps of
(i) reacting a polyurethane prepolymer having isocyanate groups with at least one blocking agent selected from oximes, pyrazoles and active methylene compounds to provide a partially blocked polyisocyanate,
(ii) reacting remaining isocyanate groups in the partially blocked polyisocyanate with an amine compound having active hydrogen to provide an amine-containing blocked polyisocyanate, and
(iii) neutralizing the amine-containing blocked polyisocyanates with an acid, and
(C) a curing catalyst.

### Embodiment 2

The cathodic electrodeposition coating composition according to Embodiment 1, wherein said polyurethane prepolymer having isocyanate groups is obtainable or obtained by a reaction of polyisocyanate and polyol.

### Embodiment 3

The cathodic electrodeposition coating composition according to any one of Embodiments 1 to 2, wherein said partially blocked polyisocyanate is obtainable or obtained by a process comprising steps of
(i-1) preparing a polyurethane prepolymer having isocyanate groups by reacting a polyisocyanate with a polyol, and
(ii-2) reacting the polyurethane prepolymer having isocyanate groups obtained from step (i-1) with at least one blocking agent selected from oximes, pyrazoles and active methylene compounds.

### Embodiment 4

The cathodic electrodeposition coating composition according to any one of Embodiments 1 to 3, wherein said blocking agent is at least one selected from a group consisting of formamide oxime, acetaldoxime, acetoxime, methylethyl ketoxime, methylisobutyl ketoxime, diethyl ketoxime, diacetyl monoxime, benzophenoxime, cyclopentanoneoxime and cyclohexanoneoxime.

### Embodiment 5

The cathodic electrodeposition coating composition according to any one of Embodiments 2 to 4, wherein said polyisocyanate is at least one selected from aliphatic, cycloaliphatic and aromatic diisocyanates and polyisocyanates having at least three isocyanate groups per molecule.

### Embodiment 6

The cathodic electrodeposition coating composition according to Embodiment 5, wherein said polyisocyanate is at least one selected from a group consisting of monomers, isomers and oligomers of 1,3-phenylene diisocyanate, 1,4-phenylene diisocyanate, 2,4-tolylene diisocyanate, 2,6-tolylene diisocyanate, 1,3-xylylene diisocyanate, 1,4-xylylene diisocyanate, 1,4-naphthylene diisocyanate, 1,5-naphthylene diisocyanate, biphenylene diisocyanate, 4,4′-diphenylmethane diisocyanate, 2,4′-diphenylmethane diisocyanate, 2,2′-diphenylmethane diisocyanate, 4,4′-diphenyl ether diisocyanate and 2,2-diphenylpropane-4,4′-diisocyanate.

### Embodiment 7

The cathodic electrodeposition coating composition according to any one of Embodiments 1 to 6, wherein said polyurethane prepolymer having isocyanate groups has a content of isocyanate groups in a range of from 70% to 90% by molar and preferably from 70% to 80% by molar based on the total amount of isocyanate groups and urethane groups in said polyurethane prepolymer.

### Embodiment 8

The cathodic electrodeposition coating composition according to any one of Embodiments 1 to 7, wherein said partially blocked polyisocyanate has a content of remaining isocyanate groups in a range of from 10% to 25% by molar and preferably from 10% to 20% by molar based on the total amount of remaining and blocked polyisocyanate groups and urethane groups contained in said partially blocked polyisocyanate.

### Embodiment 9

The cathodic electrodeposition coating composition according to any one of Embodiments 1 to 8, wherein said curing catalyst is preferably a metal catalyst, and more preferably at least one selected from a group consisting of triphenyl tin hydroxide, butyl stannoic acid, dioctyltin oxide, dibutyltin dilaurate, dibutyltin diacetate, dibutyltin oxide, oxides of titanium, hafnium, zirconium, niobium, zinc, bismuth, lead, indium, tin, copper and yttrium.

### Embodiment 10

The cathodic electrodeposition coating composition according to Embodiment 9, wherein said curing catalyst is provided in a form of paste comprising grinding resin, pigment, filler and catalyst.

### Embodiment 11

The cathodic electrodeposition coating composition according to any one of Embodiments 1 to 10, wherein it further comprises a curing agent (D) that is other than said blocked polyisocyanate having neutralized amine.

### Embodiment 12

The cathodic electrodeposition coating composition according to claim 9, wherein said blocked polyisocyanate having neutralized amine has a content of at least 10% by weight and preferably at least 20% by weight based on the total amount of said blocked polyisocyanate having neutralized amine and curing agent (D).

### Embodiment 13

A method for preparing said cathodic electrodeposition coating composition according to any one of Embodiments 1 to 12 comprising a step of mixing an aqueous dispersion comprising said cationic amino-containing epoxy resin, an aqueous dispersion comprising said blocked polyisocyanate having neutralized amine and a catalyst.

### Embodiment 14

The method according to Embodiment 13, wherein said aqueous dispersion comprising said cationic amino-containing epoxy resin is prepared by neutralizing an amino-containing epoxy resin with an acid and dispersing in water.

### Embodiment 15

The method according to any one of Embodiments 13 to 14, wherein a curing agent (D) is added into said aqueous dispersion comprising said cationic amino-containing epoxy resin.

### Embodiment 16

A coating bath for cathodic electrodeposition comprising a cathodic electrodeposition coating composition according to any one of Embodiments 1 to 12.

### Embodiment 17

A coating bath for cathodic electrodeposition comprising a cathodic electrodeposition coating composition prepared by the method according to any one of claims 13 to 15.

### EXAMPLES

The invention will be further illustrated by following Examples, which set forth particularly advantageous embodiments. While the Examples are provided to illustrate the present invention, they are not intended to limit it.

### Description of Materials and Measurements

### Materials:

Lupranate® M20S: Solvent-free polymeric product based on 4,4′-diphenylmethane diisocyanate (MDI) containing oligomers and isomers, having an average functionality of about 2.7, and NCO content 31.5 g/100 g according to ASTM D 5155, available from BASF;
CathodGuard® 800: A set of electrocoating materials including two separate packages, i.e., one package of pigment paste with a solid content of 65 wt %, and one package of aqueous binder dispersion of cationic amino-containing epoxy resin and of curing agent with a solid content of 37.5 wt %, available from BASF;
Pluriol® C 1651: Dibutoxyethoxyformal, available from BASF;
BE-188EL: liquid Bisphenol A epoxy resin having an epoxy equivalent of approx. 188 g/mol, available from Chang Chun Group;
PPG 900: Pluriol® P 900 available from BASF;
Bisphenol A 6EO: Bisphenol A ethoxylate with 3 EO/phenol, available from Sigma-Alrdrich;
MIBK: methyl isobutyl ketone, a solvent;
MEKO: methyl ethyl ketoxime, a blocking agent;
MDEA: N-methyl diethanolamine;
DMAPA: N, N-dimethylaminopropylamine.

### Measurements:

The methods and devices as described in following Table were used for the measurements in Examples.

| Method | Standards | Device Name |
|---|---|---|
| Solid content, 130° C., 60 | DIN EN ISO 3251 | Oven, Binder FD 53 |
| mins | | |
| MEQ-A (mmol/100 g) | DIN EN ISO 15880 | Titrator, Metrohm Titrando 904 |
| MEQ-B (mmol/100 g) | DIN EN ISO 15880 | Titrator, Metrohm Titrando 904 |
| pH (20° C.) | DIN 55659-1 | PH meter, Mettler Toledo S220 |
| Conductivity(mS/cm), 20° C. | DIN EN ISO 15091 | Conductivity meter, Mettler Toledo |
| | | S230 |
| Particle size (nm), | DIN ISO 13321 | Paticle size analyzer, Malvern, |
| Z-average | | Zetasizer Nano zs90 (model ZEN3690) |
| Particle size distribution, | DIN ISO 13321 | Paticle size analyzer, Malvern, |
| polydispersity index (PDI) | | Zetasizer Nano zs90 (model ZEN3690) |
| Ra | DIN EN ISO 4287- | Mobile roughness measuring |
| | 1998 | instrument, Mahr, MarSurf M300C |
| Erichsen identation test | DIN EN ISO 1520 | Paint and lacquer testing machine, |
| | EN | Erichsen, Model 202 EM |
| Hardness | GB/T 6739-2006 | Pencil Hardness Tester |
| Climate corrosion test (CCT) | PV 1210: 2021-02 | Climate corrosion test machine, Köhler |
| | | HKS 2000 |
| Baking loss | DIN 55655-9 | Oven, Binder FDL115 |
| | | Balance, ML503 |
| Throw power, 4 panels-3 | ISO 22553-2 | Fischer thickness meter, DualScope |
| boxes | | FMP40 |

### I. Preparation Examples

### Example 1: Preparation of Butyl Glycol Blocked Polyisocyanate (Conventional)

494.8 parts by weight of methyl isobutyl ketone (MIBK), 789.1 parts by weight of butyl glycol, and 0.90 parts by weight of dibutyltin dilaurate (DBTL) were charged into a reactor equipped with a condenser, a nitrogen gas inlet and a nitrogen gas outlet. The initial charge was heated to 50° C., to which 933.8 parts by weight of Lupranate® M20S, was slowly dosed into the reactor over 60 min with continuous stirring. After finishing dosing, 175.2 parts by weight of phenoxy propanol (POP) as a solvent was subsequently added into the reactor. A butyl glycol blocked polyisocyanate curing agent was obtained.

### Example 2: Preparation of MEKO-Blocked Polyisocyanate Containing Amine Building Blocks (Unneutralized)

900 parts by weight of Lupranate® M20S, 218.6 parts by weight of MIBK, and 0.18 parts by weight of DBTL were charged into a reactor equipped with a condenser, a nitrogen gas inlet and a nitrogen gas outlet. The initial charge was heated to 30° C., to which 56.2 parts by weight of 1,2-propandiol was being dosed into the reactor in a uniform rate over 60 mins with a continuous stirring. 546.5 parts by weight of MIBK was then added into the reactor, and the content in the reactor was cooled to 30° C. At 30° C., 343.4 parts by weight of MEKO was slowly dosed into the reactor over 20 mins. After finishing dosing MEKO, the reaction was raised up to 60° C. and continued for another 30 mins. The obtained intermediate was immediately transferred to a dropping funnel, and then installed into a second clean reactor equipped with a condenser, a nitrogen gas inlet and a nitrogen gas outlet. 120.8 parts by weight of DMAPA was initially charged into the second reactor, and heated to 30° C. Thereafter, the intermediate in the dropping funnel was being dosed into the reactor in a uniform rate over 60 mins with a continuous stirring. 30 mins after finishing dosing, the reaction mixture was raised up to 60° C. and stirred for another 15 mins. A MEKO-blocked polyisocyanate curing agent containing unneutralized amine building units was obtained.

### Example 3: Preparation of Self-Emulsifying Curing Agent-MEKO-Blocked Polyisocyanate Containing Neutralized Amine Building Blocks

A reactor equipped with a condenser, a nitrogen gas inlet and a nitrogen gas outlet, was charged with 150.9 parts by weight of MEKO, 19.7 parts by weight of 1,2-propanediol, 408 parts by weight of methyl isobutyl ketone (MIBK), and 0.18 parts by weight of dibutyltin dilaurate (DBTL). This initial charge was heated to 30° C. Thereafter, over a period of 60 mins, 400 parts by weight of Lupranate® M20S was being dosed into the reactor in a uniform rate with continuous stirring. After finishing dosing, the reaction temperature was cooled down to 60° C. and stirred for another 60 mins. Then, after cooling to 30° C., 41.3 parts by weight of MDEA was dosed into the reactor with a dosing rate such that the temperature was not higher than 80° C. 30 mins after finishing dosing, the reaction mixture was raised up to a temperature of 80° C. and stirred for another 60 mins, obtaining an organic system comprising amine-containing MEKO-blocked polyisocyanates. A mixture of 510 parts by weight of water and 23.1 parts by weight of formic acid (86%) was then added into the organic system with an intensive string to obtain an aqueous dispersion of blocked polyisocyanate having neutralized amine. The characteristics of the resulting aqueous dispersion are shown in Table 1 below.

### Example 4: Preparation of Self-Emulsifying Curing Agent-MEKO-Blocked Polyisocyanate Containing Neutralized Amine Building Blocks

500 parts by weight of Lupranate® M20S, 121.4 parts by weight of MIBK and 0.23 parts by weight of DBTL were charged into a reactor equipped with a condenser, a nitrogen gas inlet and a nitrogen gas outlet. This initial charge was heated to 30° C. Then, 31.2 parts by weight of 1,2-propanediol was being dosed into the reactor in a uniform rate over 60 mins with continuous stirring. 303.6 parts by weight of MIBK was then added into the reactor, and the content in the reactor was cooled to 30° C. At 30° C., 190.8 parts by weight of MEKO was slowly dosed into the reactor over 20 mins. After finishing dosing MEKO, the reaction was raised up to a temperature of 60° C. and continued for another 30 mins. The obtained intermediate was immediately transferred to a dropping funnel, and then installed into a second clean reactor equipped with a condenser, a nitrogen gas inlet and a nitrogen gas outlet. 67.1 parts by weight of DMAPA was initially charged into the second reactor, and heated to 30° C. Thereafter, the intermediate in the dropping funnel was being dosed into the reactor in a uniform rate over 60 min with continuous stirring. 30 mins after finishing dosing, the reaction mixture was raised up to 60° C. and stirred for another 15 mins. The obtained organic system was transferred into a plastic container. A mixture of 36.9 parts by weight of water and 19.9 g formic acid (86%) was then slowly added into that organic system to create water in oil phase. Then, additional 1700 parts by weight of water was charged for phase inversion to oil in water phase. The characteristics of the resulting aqueous dispersion are shown in Table 1 below.

### Example 5: Preparation of Self-Emulsifying Curing Agent-MEKO-Blocked Polyisocyanate Containing Neutralized Amine Building Blocks

450 parts by weight of Lupranate® M20S, 131.6 parts by weight of MIBK, and 0.20 parts by weight of DBTL were charged into a reactor equipped with a condenser, a nitrogen gas inlet and a nitrogen gas outlet. The initial charge was heated to 30° C. Then, 309.0 parts by weight of Bisphenol A 6EO was being dosed into the reactor in a uniform rate over 60 mins with continuous stirring. 328.9 parts by weight of MIBK was subsequently added into the reactor, and the content in the reactor was cooled to 30° C. At 30° C., 171.0 parts by weight of MEKO was slowly dosed into the reactor over 20 mins. After finishing dosing MEKO, the reaction was raised up to a temperature of 60° C. and continued for another 30 mins. The obtained intermediate was immediately transferred to a dropping funnel, and then installed into a second clean reactor equipped with a condenser, a nitrogen gas inlet and a nitrogen gas outlet. 60.2 parts by weight of DMAPA was initially charged into this second reactor, and heated to 30° C. Thereafter, the intermediate in the dropping funnel was being dosed into the reactor in a uniform rate over 60 mins with continuous stirring. 30 mins after finishing dosing, the reaction mixture was raised up 60° C. again and stirred for another 15 mins. The obtained organic system was transferred into a plastic container. A mixture of 35.8 parts by weight of water and 18.9 parts by weight of formic acid (86%) was then slowly added into that organic system to create water in oil phase. Then, additional 2050 parts by weight of water was charged for phase inversion to oil in water phase. The characteristics of the resulting aqueous dispersion are shown in Table 1 below.

### Example 6: Preparation of Self-Emulsifying Curing Agent-MEKO-Blocked Polyisocyanate Containing Neutralized Amine Building Blocks

500 parts by weight of Lupranate® M20S, 112.3 parts by weight of MIBK, and 0.23 parts by weight of DBTL were charged into a reactor equipped with a condenser, a nitrogen gas inlet and a nitrogen gas outlet. The initial charge was heated to 30° C., to which 30.9 parts by weight of 1,2-propandiol was quickly added into the reactor. The reaction continued for 60 mins with continuous stirring at 60° C. 224.7 parts by weight of MIBK was subsequently added into the reactor, and the content in the reactor was cooled to 30° C. At 30° C., 188.8 parts by weight of MEKO was slowly dosed into the reactor over 20 mins. After finishing dosing MEKO, the reaction was raised up to 60° C. again and continued for another 30 mins. After cooling to 30° C., 66.4 parts by weight of DMAPA was quickly charged into the reactor. 20 mins after finishing charging, the reaction mixture was raised up to 60° C. and stirred for another 30 mins. The obtained organic system was afterwards transferred into a plastic container. A mixture of 38.9 parts by weight of water and 20.9 parts by weight of formic acid (86%) was then slowly added into the organic system to create water in oil phase. Then, additional 1960.5 parts by weight of water was charged for phase inversion to oil in water phase. The characteristics of the resulting aqueous dispersion are shown in Table 1 below.

TABLE 1

| | Solid | MEQ-A | MEQ-B | | Con- | Particle | |
|---|---|---|---|---|---|---|---|
| | content | (mmol/ | (mmol/ | | ductivity | size | |
| | (wt %) | 100 g) | 100 g) | pH | (mS/cm) | (nm) | PDI |
| Example 3 | 27.2 | 73.6 | 63.2 | 3.41 | 4.42 | 175 | 0.13 |
| Example 4 | 28.1 | 59.2 | 98.1 | 4.49 | 7.14 | 133 | 0.08 |
| Example 5 | 25.1 | 46.2 | 74.8 | 7.09 | 3.97 | 122 | 0.10 |
| Example 6 | 24.0 | 54.5 | 86.1 | 7.15 | 3.24 | 123 | 0.05 |

### Example 7: Preparation of an Aqueous Dispersion of Cationic Amino-Containing Epoxy Resin

An amino-containing epoxy resin was prepared with reference to U.S. Pat. No. 6,274,649B1, column 9, lines 15 to 35. 1128 parts by weight of a liquid Bisphenol A epoxy resin (BE-188EL), 262 parts by weight of dodecylphenol, 31.4 parts by weight of xylene and 228 parts by weight of bisphenol A were charged into a reactor fitted with stirrer, reflux condenser, thermometer and inert-gas inlet. The reactor was heated to 127° C., to which 1.6 g of triphenylphosphine are added with stirring under nitrogen to start an exothermic reaction, and the temperature rose to 160° C. The mixture was cooled again to 130° C. and the epoxide content was then checked. Once the epoxide content indicated that >98% of the phenolic OH groups have reacted, 297.5 parts by weight of PPG 900 was then added with simultaneous cooling. After 5 mins, 131.25 parts by weight of diethanolamine (DEOLA) was added at 120° C. with further cooling. When the temperature has dropped to 110° C., 63.75 parts by weight of N, N-dimethylaminopropylamine (DMAPA) was added. After brief exothermicity (Tₘₐₓ of 140° C.), the mixture was allowed to react further at 130° C. for 2 hours until the viscosity remains constant, to obtain an organic system comprising the amino-containing epoxy resin.

Thereafter, the organic system comprising the amino-containing epoxy resin was immediately transferred into a plastic container containing a mixture of 3840 parts by weight of water and 48.8 parts by weight of formic acid (86%) with stirring, to obtain an aqueous dispersion of cationic amino-containing epoxy resin. The characteristics of the resulting dispersion are shown in Table 2 below.

TABLE 2

| | Solid | MEQ-A | MEQ-B | | Con- | Particle | |
|---|---|---|---|---|---|---|---|
| | content | (mmol/ | (mmol/ | | ductivity | size | |
| Sample | (wt %) | 100 g) | 100 g) | pH | (mS/cm) | (nm) | PDI |
| Example 12 | 33.1 | 36.8 | 114.0 | 6.65 | 3.11 | 62 | 0.11 |

### Example 8: Preparation of a Binder Dispersion Comprising a Conventional Curing Agent

To 1353 parts by weight of the organic system comprising the amino-containing epoxy resin as prepared intermediately in Example 7, 470.6 parts by weight of the butyl glycol blocked polyisocyanate curing agent as prepared in Example 1 was added and stirred for 20 mins to mix homogeneously. Then, the obtained organic mixture was immediately transferred into a plastic container which contains a mixture of 2609.1 parts by weight of water and 30.4 parts by weight of formic acid (86%). A binder dispersion comprising a resin component and a conventional curing agent component was obtained. The characteristics of the dispersion are shown in Table 3 below.

### Example 9: Preparation of a Binder Dispersion Comprising a Conventional Curing Agent

To 1353 parts by weight of the organic system comprising the amino-containing epoxy resin as prepared intermediately in Example 7, 294.1 parts by weight of the butyl glycol blocked polyisocyanate curing agent as prepared in Example 1 was added and stirred for 20 mins to mix homogeneously. The obtained organic mixture was immediately transferred into a plastic container, which contains a mixture of 2475.1 parts by weight of water and 30.9 parts by weight of formic acid (86%). A binder dispersion comprising a resin component and a conventional curing agent component was obtained. The characteristics of the dispersion are shown in Table 3 below.

### Example 10: Preparation of a Binder Dispersion Comprising a Conventional Curing Agent

To 1353 parts by weight of the organic system comprising the amino-containing epoxy resin as prepared intermediately in Example 7, 117.6 parts by weight of the butyl glycol blocked polyisocyanate curing agent as prepared in Example 1 was added and stirred for 20 mins to mix homogeneously. The obtained organic mixture was immediately transferred into a plastic container, which contains a mixture of 2341.6 parts by weight of water and 31.8 parts by weight of formic acid (86%). A binder dispersion comprising a resin component and a conventional curing agent component was obtained. The characteristics of the dispersion are shown in Table 3 below.

### Example 11: Preparation of a Binder Dispersion Comprising MEKO-Blocked Polyisocyanate Curing Agent Containing Unneutralized Amine Building Units

To 680.8 parts by weight of the organic system comprising the amino-containing epoxy resin as prepared intermediately in Example 7 at 75° C., 111.1 parts by weight of MIBK was added together with 413.9 parts by weight of the MEKO-blocked polyisocyanate curing agent containing unneutralized amine building units as prepared in Example 2 and stirred for 20 min to mix homogeneously. The obtained organic mixture was immediately transferred into a plastic container, which contains a mixture of 1632.8 parts by weight of water and 15.3 parts by weight of formic acid (86%). A binder dispersion comprising a resin component and a curing agent component not according to the present invention was obtained. The characteristics of the dispersion are shown in Table 3 below.

TABLE 3

| | Solid | MEQ-A | MEQ-B | | Con- | Particle | |
|---|---|---|---|---|---|---|---|
| | content | (mmol/ | (mmol/ | | ductivity | size | |
| | (wt %) | 100 g) | 100 g) | pH | (mS/cm) | (nm) | PDI |
| Example 8 | 37.8 | 33.4 | 85.5 | 6.34 | 3.12 | 106 | 0.15 |
| Example 9 | 37.2 | 40.0 | 90.8 | 6.56 | 2.68 | 68 | 0.15 |
| Example 10 | 34.5 | 33.4 | 85.7 | 6.18 | 3.18 | 70 | 0.24 |
| Example 11 | 34.8 | 36.8 | 99.5 | 6.63 | 2.59 | 193 | 0.09 |

### Examples 12 to 14: Preparation of a Binder Dispersion Comprising a Self-Emulsifying Curing Agent Component

A self-emulsifying curing agent dispersion as prepared in Examples 3 to 5 and the aqueous dispersion of cationic amino-containing epoxy resin as prepared in Example 7 (i.e., resin dispersion) were mixed together with moderate stirring to get a homogeneous mixture. A 1K binder dispersion was thus obtained. The formulations and characteristics of the 1K binder dispersions are shown in Tables 4 and 5 below.

TABLE 4

| Formulations, | | | | |
|---|---|---|---|---|
| parts by weight | | Example 12 | Example 13 | Example 14 |
| Resin dispersion | Example 7 | 2355.6 | 1450.0 | 1800.0 |
| Curing agent | Example 3 | 1345.5 | — | — |
| dispersion | Example 4 | — | 650.8 | — |
| | Example 5 | — | — | 900.0 |

TABLE 5

| | Solid | MEQ-A | MEQ-B | | Con- | Particle | |
|---|---|---|---|---|---|---|---|
| | content | (mmol/ | (mmol/ | | ductivity | size | |
| | (wt %) | 100 g) | 100 g) | pH | (mS/cm) | (nm) | PDI |
| Example 12 | 32.1 | 58.6 | 96.7 | 5.32 | 3.57 | 180 | 0.21 |
| Example 13 | 29.2 | 41.3 | 114.6 | 6.43 | 4.20 | 95 | 0.12 |
| Example 14 | 28.6 | 40.0 | 103.0 | 6.72 | 3.38 | 82 | 0.22 |

### Examples 15 to 20: Preparation of a Binder Dispersion Comprising a Self-Emulsifying Curing Agent and a Conventional Curing Agent

A part of a self-emulsifying curing agent dispersion and a part of a dispersion comprising a resin and a conventional curing agent as prepared in Examples 8 to 10 were mixed together with moderate stirring to get homogeneous mixture. A 1K binder dispersion was thus obtained. The formulations and characteristics of the 1K binder dispersions are shown in Tables 6 and 7 below.

TABLE 6

| Formulations | | | | | | | |
|---|---|---|---|---|---|---|---|
| (parts by weight) | | Example 15 | Example 16 | Example 17 | Example 18 | Example 19 | Example 20 |
| Part 1)* | Example 8 | 2190.6 | — | — | — | — | — |
| | Example 9 | — | 2100.0 | — | 2056.1 | — | 1930.3 |
| | Example 10 | — | — | 1900.0 | — | 2284.9 | — |
| Part 2)** | Example 3 | 175.3 | 438.3 | 671.6 | — | — | — |
| | Example 5 | — | — | — | 430.8 | 896.8 | — |
| | Example 6 | — | — | — | — | — | 475.9 |

*1) Dispersion comprising a resin and a conventional curing agent
**2) Self-emulsifying curing agent dispersion

TABLE 7

| | Solid | MEQ-A | MEQ-B | | Con- | Particle | |
|---|---|---|---|---|---|---|---|
| | content | (mmol/ | (mmol/ | | ductivity | size | |
| Sample | (wt %) | 100 g) | 100 g) | pH | (mS/cm) | (nm) | PDI |
| Example 15 | 38.2 | 37.2 | 80.4 | 5.84 | 3.38 | 146 | 0.27 |
| Example 16 | 37.5 | 46.9 | 85.2 | 5.77 | 3.72 | 293 | 0.57 |
| Example 17 | 31.3 | 54.6 | 96.2 | 5.68 | 4.14 | 517 | 0.32 |
| Example 18 | 31.6 | 35.3 | 91.4 | 6.78 | 2.90 | 126 | 0.14 |
| Example 19 | 34.4 | 36.5 | 96.1 | 6.68 | 3.46 | 76 | 0.14 |
| Example 20 | 31.6 | 43.2 | 92.7 | 6.76 | 3.05 | 112 | 0.12 |

### II. Application Examples

### II.a Formulations

### Examples B1 to B5

Comparative and inventive cathodic electrodeposition coating (E-coat) materials were prepared by combining an aqueous binder dispersion, an aqueous pigment paste and deionized water in according with the formulations shown in Table 8. The combining was carried out by diluting the binder dispersion first with deionized water and then introducing the pigment paste, under stirring. E-coat materials B1 to B5 were obtained.

TABLE 8

| Formulations | | Comparative | Inventive | | | |
|---|---|---|---|---|---|---|
| parts by weight | | B1 | B2 | B3 | B4 | B5 |
| Binder | CathodGuard ® | 2043.0 | — | — | — | — |
| dispersion | 800 | | | | | |
| | Example 12 | — | — | — | — | 2228.0 |
| | Example 15 | — | 1940.0 | — | — | — |
| | Example 16 | — | — | 1956.0 | — | — |
| | Example 17 | — | — | — | 2302.0 | — |
| Pigment | CathodGuard ® | 497.0 | 497.0 | 497.0 | 497.0 | 497.0 |
| paste | 800 | | | | | |

| | | | | | |
|---|---|---|---|---|---|
| Deionized water | 2610.0 | 2712.0 | 2696.0 | 2350.0 | 2424.0 |
| Total | 5150.0 | 5149.0 | 5149.0 | 5149.0 | 5149.0 |

### Examples B6 and B7

Comparative and inventive cathodic electrodeposition coating (E-coat) materials were prepared by combining an aqueous binder dispersion, an aqueous pigment paste and deionized water in according with the formulations shown in Table 9. The combining was carried out by diluting the binder dispersion first with deionized water and then introducing the pigment paste and then Pluriol® C 1651, under stirring. E-coat materials B6 and B7 were obtained.

TABLE 9

| Formulations | | Comparative | Inventive |
|---|---|---|---|
| (parts by weight) | | Example B6 | Example B7 |
| Binder dispersion | Example 11 | 1098.0 | — |
| | Example 13 | — | 1183.0 |
| Pigment paste | CathodGuard ® 800 | 139.0 | 121.0 |

| | | |
|---|---|---|
| Pluriol ® C 1651 | 22.5 | 20.0 |
| Deionized water | 1013.0 | 696.0 |
| Total | 2272.5 | 2032.0 |

### Examples B8 to B11

Comparative and inventive cathodic electrodeposition coating (E-coat) materials were prepared by combination of an aqueous binder dispersion, an aqueous pigment paste and deionized water in according with the formulations shown in Table 10. The combination was carried out by diluting the binder dispersion first with deionized water and then introducing the pigment paste and then Pluriol® C 1651, under stirring. E-coat materials B8 to B11 were obtained.

TABLE 10

| | | Comparative | Inventive | | |
|---|---|---|---|---|---|
| | | B8 | B9 | B10 | B11 |
| Formulations, | | | | | |
| parts by weight | | | | | |
| Binder dispersion | CathodGuard ® 800 | 1745.0 | — | — | — |
| | Example 18 | — | 2152.0 | — | — |
| | Example 19 | — | — | 1938.0 | — |
| | Example 14 | — | — | — | 2347.0 |
| Pigment paste | CathodGuard ® 800 | 330.0 | 363.0 | 358.0 | 364.0 |

| | | | | |
|---|---|---|---|---|
| Pluriol ® C 1651 | 0.0 | 40.0 | 40.0 | 60.0 |
| Deionized water | 1925.0 | 1888.0 | 2040.0 | 1704.0 |
| Total | 4000.0 | 4443.0 | 4376.0 | 4475.0 |
| Properties | | | | |
| Solid content | 19.2% | 19.5% | 19.6% | 20.1% |
| Ash content | 18.6% | 18.6% | 18.4% | 18.4% |
| pH | 5.95 | 6.65 | 6.67 | 6.71 |
| Conductivity (mS/cm) | 1.71 | 1.86 | 2.10 | 2.17 |

### Examples B12 to B17

Comparative and inventive cathodic electrodeposition coating (E-coat) materials were prepared by combining an aqueous binder dispersion, an aqueous pigment paste and deionized water in according with the formulations shown in Table 11. The combining was carried out by diluting the binder dispersion first with deionized water and then introducing the pigment paste, under stirring. E-coat materials B12 to B17 were obtained.

TABLE 11

| Formulations, | | Comparative | | | Inventive | | |
|---|---|---|---|---|---|---|---|
| parts by weight | | B12 | B13 | B14 | B15 | B16 | B17 |
| Binder | CathodGuard ® 800 | 2110.0 | 2110.0 | 2110.0 | — | — | — |
| dispersion | Example 20 | — | — | — | 2757.0 | 2757.0 | 2757.0 |
| Pigment paste | CathodGuard ® 800 | 347.0 | 419.0 | 496.0 | 361.0 | 465.0 | 508.0 |

| Deionized water | 2949.0 | 3131.0 | 3383.0 | 2494.0 | 2757.0 | 2848.0 |
|---|---|---|---|---|---|---|
| Total | 5406.0 | 5660.0 | 5989.0 | 5612.0 | 5979.0 | 6114.0 |
| | Comparative | | | Inventive | | |
| Properties | B12 | B13 | B14 | B15 | B16 | B17 |
| Solid content (wt %) | 17.8% | 18.0% | 18.0% | 18.0% | 18.1% | 18.1% |
| Ash content (wt %) | 15.3% | 17.9% | 20.1% | 15.1% | 18.1% | 19.9% |
| pH | 5.70 | 5.70 | 5.60 | 6.27 | 6.28 | 6.30 |
| Conductivity (mS/cm) | 1.51 | 1.50 | 1.51 | 1.94 | 1.88 | 1.89 |

### II.b Measurements

### (1). General Procedure for Cathodic Electrodeposition Coating

The E-coat materials as coating bath were aged with stirring at room temperature for 1 day unless otherwise specified. Films were deposited over 2 min at a deposition voltage of 260 volts onto cathodically connected, zinc-phosphatized steel test panels (26S/6800/OC or 26/1/6800 MBZ), at a bath temperature of around 30° C. The deposited films were rinsed with deionized water, and then baked at 175° C. (substrate temperature for 15 min) for general tests unless otherwise specified.

### (2). Dynamic Mechanical Analysis (DMA) Test

The E-coat materials B1 to B5 were tested by DMA Q800 dynamic mechanical analyzer from TA instruments. The test settings are summarized below and the results are shown in Table 12.

### Onset Temperature Test Setting:

Film/fiber tensile clamp;
Sample size: 10 mm (L)*6.5 mm (W);
Strain: 0.05%, Frequency: 1 Hz; and
Ramp 2° C./min to 110° C.; ramp 1.3° C./min to 205° C.

### Offset Time Test Setting:

Film/fiber tensile clamp;
Sample size: 10 mm (L)*6.5 mm (W);
Strain: 0.05%, Frequency: 1 Hz; and
Ramp (T-25)/10° C./min, then isothermal for 60 min at the defined temperature.

TABLE 12

| | Content of | Onset | Offset time |
|---|---|---|---|
| | self-emulsifying | temperature | at 140° C. |
| Sample | curing agent* (wt %) | (° C.) | (min) |
| Example B1 | 0 | 145.61 | N.A. |
| Example B2 | 20 | 114.66 | 36.03 |
| Example B3 | 50 | 112.87 | 22.13 |
| Example B4 | 80 | 110.42 | 18.73 |
| Example B5 | 100 | 109.15 | 16.88 |

*Based on the sum of the self-emulsifying curing agent and the conventional curing agent

As shown in the Table 12, for all Samples B2, B3, B4 and B5 comprising the self-emulsifying curing agent, gelation of the E-coat films happened at a temperature lower than 120° C., and the films can be well cured at 140° C. within 36.03 min, 22.13 min, 18.73 min and 16.88 min respectively. In contrast, the Sample B1 which comprising no self-emulsifying curing agent cannot be cured at 140° C.

### (3). Stability Test Via Differential Scanning Calorimetry (DSC)

The Sample B5 was tested for the aging stability. E-coat films were prepared in accordance with the general procedural as described above, using Sample B5 in fresh state, after 2-week aging and after 4-week aging as the coating bath. The E-coat films were baked under different temperatures and different periods as summarized in Table 13 below. The Tgs of the baked E-coat films were tested and the results are shown in Table 13.

TABLE 13

| | DSC test, | DSC test, | DSC test, |
|---|---|---|---|
| | from fresh | from 2-week | from 4-week |
| | bath Tg | aging bath Tg | aging bath Tg |
| Curing condition | (° C.) | (° C.) | (° C.) |
| 110° C., 25 min | 73 | 69 | 74 |
| 120° C., 25 min | 81 | 79 | 82 |
| 130° C., 25 min | 83 | 88 | 85 |
| 140° C., 25 min | 88 | 88 | 86 |
| 150° C., 25 min | 94 | 91 | 88 |
| 160° C., 25 min | 95 | 101 | 95 |
| 170° C., 25 min | 98 | 103 | 102 |
| 180° C., 25 min | 97 | 103 | 105 |
| 190° C., 30 min | 98 | 102 | 106 |
| 200° C., 40 min | 102 | 97 | 101 |

Apparently, there is no significant increase of Tg of the baked E-coat films from baths in fresh state, after 2-week aging and after 4-week aging, at low curing temperature conditions, which means there is no gelation happening during a long-term aging of the bath. In other words, the E-coat material according to the present invention has a good aging stability for at least 4 weeks.

### (4). Stability Test Via Roughness Measurement

The aging stability of the E-coat material can also be monitored by the appearance change of the E-coat film. The better aging stability, the fewer roughness changes, while the worse aging stability, the higher roughness changes. E-coat films were prepared on 26/1/6800 MBZ panel in accordance with the general procedural as described above, using Sample B6 and Sample B7 as the coating bath. The films were measured for roughness change and the test results are shown in Table 14.

TABLE 14

| | Roughness Ra (μm), | Roughness Ra (μm), |
|---|---|---|
| Sample | from fresh bath | from 2-week aging bath |
| B6 (Comparative) | 0.54 | 0.93 |
| B7(Inventive) | 0.73 | 0.76 |

Apparently, the film prepared from sample B6 after 2-week aging has a significantly higher Ra value than the film of from sample B6 in fresh state. In contrast, the films prepared from sample B7 in fresh state and after 2-week aging have no significant change of Ra values. The E-coat material according to the present invention has improved aging stability, compared with the E-coat material comprising an amino-containing epoxy resin and a curing agent which were neutralized and dispersed together.

### (5). Other Performances Tests

Application performances were also tested for the E-coat films as prepared from samples B8 to B17 in accordance with the general procedural as described above. The test results are shown in Tables 15 and 16.

TABLE 15
Performance Tests of the E-coat film on 26/1/6800 MBZ panel

| | Comparative | Inventive | | |
|---|---|---|---|---|
| | E-coat material | E-coat material | | |
| Test | B8 | B9 | B10 | B11 |
| Erichsen identation test (mm) | 10.5 | 11.1 | 11.2 | 10.3 |
| Hardness | 3H | 3H | 3H | 3H |
| Climate corrosion test (CCT), | 3.04 | 2.38 | 2.40 | 2.64 |
| Delamination after 30 cycles (mm) | | | | |

TABLE 16
Performance Tests of the E-coat film on 26S/6800/OC panel

| | Comparative | | | Inventive | | |
|---|---|---|---|---|---|---|
| | E-coat materials | | | E-coat materials | | |
| Test | B12 | B13 | B14 | B15 | B16 | B17 |
| Baking loss | 11.13% | 11.53% | 11.09% | 6.38% | 6.09% | 5.82% |
| for 175° C. | | | | | | |
| Throw power, | 62.29% | 59.16% | 62.23% | 79.56% | 81.97% | 79.05% |
| 4 panels-3 boxes | | | | | | |

It can be seen that the cathodic electrodeposition coating compositions according to the present invention have improved stability, while providing desirable film properties such as higher or comparable flexibility, higher corrosion resistance, and desirable application performances such as significantly reduced VOC and higher throw power.

1. A cathodic electrodeposition coating composition comprising
(A) a cationic amino-containing epoxy resin,
(B) a blocked polyisocyanate having neutralized amine which is obtained by a process comprising steps of
(i) reacting a polyurethane prepolymer having isocyanate groups with at least one blocking agent selected from the group consisting of oximes, pyrazoles and active methylene compounds to provide a partially blocked polyisocyanate,
(ii) reacting remaining isocyanate groups in the partially blocked polyisocyanate with an amine compound having active hydrogen to provide an amine-containing blocked polyisocyanate, and
(iii) neutralizing the amine-containing blocked polyisocyanates with an acid, and
(C) a curing catalyst.

2. The cathodic electrodeposition coating composition according to claim 1, wherein said polyurethane prepolymer having isocyanate groups is obtained by a reaction of polyisocyanate and polyol.

3. The cathodic electrodeposition coating composition according to claim 1, wherein step (i) said partially blocked polyisocyanate is obtained by a process comprising steps of
(i-1) preparing a polyurethane prepolymer having isocyanate groups by reacting a polyisocyanate with a polyol, and
(ii-2) reacting the polyurethane prepolymer having isocyanate groups obtained from step (i1) with at least one blocking agent selected from the group consisting of oximes, pyrazoles and active methylene compounds.

4. The cathodic electrodeposition coating composition according to claim 1, wherein said blocking agent is at least one selected from the group consisting of formamide oxime, acetaldoxime, acetoxime, methylethyl ketoxime, methylisobutyl ketoxime, diethyl ketoxime, diacetyl monoxime, benzophenoxime, cyclopentanoneoxime, and cyclohexanoneoxime.

5. The cathodic electrodeposition coating composition according to claim 1, wherein said polyisocyanate is at least one selected from the group consisting of aliphatic, cycloaliphatic, aromatic diisocyanates, and polyisocyanates having at least three isocyanate groups per molecule.

6. The cathodic electrodeposition coating composition according to claim 5, wherein said polyisocyanate is at least one selected from the group consisting of monomers, isomers, and oligomers of 1,3-phenylene diisocyanate, 1,4-phenylene diisocyanate, 2,4-tolylene diisocyanate, 2,6-tolylene diisocyanate, 1,3-xylylene diisocyanate, 1,4-xylylene diisocyanate, 1,4-naphthylene diisocyanate, 1,5-naphthylene diisocyanate, biphenylene diisocyanate, 4,4′-diphenylmethane diisocyanate, 2,4′-diphenylmethane diisocyanate, 2,2′-diphenylmethane diisocyanate, 4,4′-diphenyl ether diisocyanate, and 2,2-diphenylpropane-4,4′-diisocyanate.

7. The cathodic electrodeposition coating composition according to claim 1, wherein said polyurethane prepolymer having isocyanate groups has a content of isocyanate groups in a range of from 70% to 90% by molar based on the total amount of isocyanate groups and urethane groups in said polyurethane prepolymer.

8. The cathodic electrodeposition coating composition according to claim 1, wherein said partially blocked polyisocyanate has a content of remaining isocyanate groups in a range of from 10% to 25% by molar based on the total amount of remaining, blocked polyisocyanate groups and urethane groups contained in said partially blocked polyisocyanate.

9. The cathodic electrodeposition coating composition according to claim 1, wherein said curing catalyst is a metal catalyst.

10. The cathodic electrodeposition coating composition according to claim 9, wherein said curing catalyst is provided in a form of paste comprising grinding resin, pigment, filler and catalyst.

11. The cathodic electrodeposition coating composition according to claim 1, wherein it further comprises a curing agent (D) that is other than said blocked polyisocyanate having neutralized amine.

12. The cathodic electrodeposition coating composition according to claim 9, wherein said blocked polyisocyanate having neutralized amine has a content of at least 10% by weight based on the total amount of said blocked polyisocyanate having neutralized amine and curing agent (D).

13. A method for preparing said cathodic electrodeposition coating composition according to claim 1 comprising a step of mixing an aqueous dispersion comprising said cationic amino-containing epoxy resin, an aqueous dispersion comprising said blocked polyisocyanate having neutralized amine and a catalyst.

14. The method according to claim 13, wherein said aqueous dispersion comprising said cationic amino-containing epoxy resin is prepared by neutralizing an amino-containing epoxy resin with an acid and dispersing in water.

15. The method according to claim 13, wherein a curing agent (D) blocked polyisocyanate having neutralized amine is added into said aqueous dispersion comprising said cationic amino-containing epoxy resin.

16. A coating bath for cathodic electrodeposition comprising the cathodic electrodeposition coating composition according to claim 1.

17. A coating bath for cathodic electrodeposition comprising the cathodic electrodeposition coating composition prepared by the method according to claim 13.

18. The cathodic electrodeposition coating composition according to claim 1, wherein said polyurethane prepolymer having isocyanate groups has a content of isocyanate groups in a range of from 70% to 80% by molar based on the total amount of isocyanate groups and urethane groups in the polyurethane prepolymer.

19. The cathodic electrodeposition coating composition according to claim 1, wherein said partially blocked polyisocyanate has a content of remaining isocyanate groups in a range of from 10% to 20% by molar based on the total amount of remaining, blocked polyisocyanate groups and urethane groups contained in said partially blocked polyisocyanate.

20. The cathodic electrodeposition coating composition according to claim 9, wherein said curing catalyst is selected from the group consisting of triphenyl tin hydroxide, butyl stannoic acid, dioctyltin oxide, dibutyltin dilaurate, dibutyltin diacetate, dibutyltin oxide, oxides of titanium, hafnium, zirconium, niobium, zinc, bismuth, lead, indium, tin, copper, and yttrium.
